(19) United States
(12) Patent Application Publication
(10) Pub. No.: US 2023/0145068 A1
(43) Pub. Date: May 11, 2023

(54) Video analysis method of a compressed video by use of branching by motion vector

(71) Applicants: HYUN WOO LEE, SEOUL (KR); SI WAN SEONG, Seo (KR); SUNG JIN LEE, Gwangmyeong-si (KR)

(72) Inventors: HYUN WOO LEE, SEOUL (KR); SI WAN SEONG, Seo (KR); SUNG JIN LEE, Gwangmyeong-si (KR)

(21) Appl. No.: 17/698,292

(22) Filed: Mar. 18, 2022

(30) Foreign Application Priority Data
Nov. 11, 2021 (KR) 10-2021-0154880

(51) Int. Cl. H04N 19/513; H04N 19/139; H04N 19/172; H04N 19/46; H04N 19/157; H04N 19/176; H04N 19/167; H04N 19/114; H04N 19/105; H04N 19/177; H04N 19/20; H04N 19/85; G06V 20/40; G06V 10/22

(52) U.S. Cl. CPC H04N 19/513; H04N 19/139; H04N 19/172; H04N 19/46; H04N 19/157; H04N 19/176; H04N 19/167; H04N 19/114; H04N 19/105; H04N 19/177; H04N 19/20; H04N 19/85; G06V 20/46; G06V 10/22

(57) ABSTRACT

The present invention generally relates to a technology of effectively performing video analysis of a compressed video (e.g., H.264 AVC, H.265 HEVC) in a video analysis system. More specifically, the present invention relates to a video analysis technology of a compressed video (e.g., CCTV video) in which branching in the video analysis process is performed with referring to motion vectors which have been obtained by parsing the compressed video, so that computing resource for the video analysis of the compressed video may be lowered. The present invention may provide an advantage of lowering the computer resource which is required for analyzing a compressed video (e.g., CCTV video).

### BACKGROUND OF THE INVENTION

The present invention generally relates to a technology of effectively performing video analysis of a compressed video (e.g., H.264 AVC, H.265 HEVC) in a video analysis system.

More specifically, the present invention relates to a video analysis technology of a compressed video (e.g., CCTV video) in which branching in the video analysis process is performed with referring to motion vectors which have been obtained by parsing the compressed video, so that computing resource for the video analysis of the compressed video may be lowered.

In recent years, it is common to establish a CCTV-based video surveillance system for the purpose of crime prevention as well as proof of criminal evidence. However, the number of staff members is not enough for monitoring the CCTV cameras. In order to effectively perform video surveillance with such a limited number of staffs, it would be helpful to detect meaningful objects in CCTV video by video analysis and further display something in the corresponding region of the CCTV video on monitor screens.

The CCTV cameras usually have high definition (e.g., Full HD) and high bit-rate (e.g., 24 frames-per-second). With considering network bandwidth and storage space, high compression video technology, such as H.264 AVC, H.265 HEVC, etc., are adopted in the CCTV video. The CCTV cameras shall produce and provide video data in a form of compressed video by any one of the technical standards as above. Then, video analysis system shall receive the compressed video, perform decoding by the technical standard which has been used in encoding the compressed video, and then extracts information out of the CCTV video by video analysis.

FIG. 1 is a block diagram illustrating the general constitution of a video decoding apparatus according to H.264 AVC technical specification. Referring to FIG. 1, the video decoding apparatus comprises syntactic analyzer 11, Entropy decoder 12, inverse transformer 13, motion vector calculator 14, predictor 15, and deblocking filter 16. These hardware modules process the compressed video in sequence so as to perform decompression and recover original image data. The syntactic analyzer 11 parses the compressed video so as to obtain motion vector and coding type for each of coding unit. The coding units are generally image blocks such as macro blocks or sub-blocks.

FIG. 2 is a flow chart illustrating a conventional procedure of video analysis of a compressed video. Referring to FIG. 2, the compressed video shall be decoded by a video compression technical standard (e.g., H.264 AVC, H.265 HEVC) (S10), and then image frames of reproduced images shall be downscale resized into smaller images, e.g., 320×240 (S20). Then, differential images shall be obtained out of the resized frame images, and then objects shall be extracted by playback image analysis (S30).

In conventional solutions, video analysis of a compressed video includes decoding, downscale resizing, and image analysis. These are very complicated processing, which limits the capacity of video analysis server in conventional video surveillance systems. Currently, the maximum number of CCTV channels which a high-performance video analysis server can deal with is sixteen (16) in general. Because pluralities of CCTV cameras are being installed, video surveillance system requires pluralities of video analysis servers, which causes many problems such as cost increase and difficulty in physical space.

### SUMMARY OF THE INVENTION

It is an object of the present invention to provide a technology of effectively performing video analysis of a compressed video (e.g., H.264 AVC, H.265 HEVC) in a video analysis system.

In particular, it is another object of the present invention to provide a video analysis technology of a compressed video (e.g., CCTV video) in which branching in the video analysis process is performed with referring to motion vectors which have been obtained by parsing the compressed video, so that computing resource for the video analysis of the compressed video may be lowered.

In order to achieve the objects as above, the present invention discloses a video analysis method by which a video analysis server may analyze a compressed video by use of branching by motion vector.

The video analysis method of a compressed video by use of branching by motion vector of the present invention comprises: identifying a series of image frames out of the compressed video; sequentially selecting a target frame out of the series of image frames according to a predetermined selection rule; checking an image analysis flag; if the image analysis flag is OFF, determining detection of a region of moving object in the target frame based on a motion vector accumulation which is obtained by bit-stream parsing of the compressed video; if the image analysis flag is OFF and a region of moving object fails to be detected in the determining detection of a region of moving object, skipping image analysis for the selected target frame and proceeding to the selecting target frames; if the image analysis flag is ON or a region of moving object is detected in the determining detection of a region of moving object, determining detection of an effective object in the selected target frame by image analysis on the selected target frame; if an effective object fails to be detected in the determining detection of an effective object, setting the image analysis flag to OFF and proceeding to the selecting target frames; and if an effective object is detected in the determining detection of an effective object, setting the image analysis flag to ON and proceeding to the selecting target frames.

The video analysis method of the present invention may further comprise: if the selected target frame is a P frame which is located within a predetermined number at the rear end of the GOP, skipping image analysis for the selected target frame and proceeding to the selecting target frames.

In the present invention, the determining detection of a region of moving object may comprise: parsing the bit-stream of the compressed video so as to obtain motion vector and coding type for coding unit; obtaining motion vector accumulation for a predetermined time-period for each of a plurality of image blocks which constituting image frames of the compressed video; identifying image blocks whose motion vector accumulation are higher than a predetermined first threshold; and marking the identified image blocks as region of moving object.

In the present invention, the determining detection of a region of moving object may further comprise: identifying a plurality of image blocks (hereinafter referred to as ‘neighboring blocks’) around the image blocks which are marked as region of moving object; marking as region of moving object some of the neighboring blocks whose coding type is Intra Picture; identifying neighboring blocks whose motion vector are higher than a predetermined second threshold; further marking the identified neighboring blocks as region of moving object; performing interpolation on the image frames of the compressed video, by which unmarked image blocks which are surrounded by a plurality of marked image blocks are marked as region of moving object, wherein the marked image blocks are image blocks which are marked as region of moving object, wherein the unmarked image blocks are image blocks which are not marked as region of moving object yet, and wherein the number of unmarked image blocks is less than a predetermined threshold value; and setting a lump of marked image blocks as a region of moving object, wherein the lump is formed by clumping up the marked image blocks.

The computer program according to the present invention is stored in a medium in order to execute the video analysis method of a compressed video by use of branching by motion vector which has been set forth above by being combined with hardware.

### BRIEF DESCRIPTION OF THE DRAWINGS

FIG. 1 is a block diagram illustrating the general constitution of a video decoding apparatus.

FIG. 2 is a flow chart illustrating a conventional procedure of video analysis of a compressed video.

FIG. 3 is a flow chart illustrating an embodiment of the video analysis method according to the present invention.

FIG. 4 is a flow chart illustrating an embodiment of the procedure of extracting regions of moving object in a compressed video by use of motion vectors in the present invention.

FIG. 5 is a flow chart illustrating an embodiment of the procedure of detecting regions of effective movement in a compressed video in the present invention.

FIG. 6 is a view illustrating an example of the result of performing the procedure of detecting regions of effective movement on a CCTV video.

FIG. 7 is a flow chart illustrating an embodiment of the procedure of detecting boundary area of region of moving object in the present invention.

FIG. 8 is a view illustrating the result of performing the procedure of detecting boundary area on the CCTV video of FIG. 6.

FIG. 9 is a view illustrating the result of performing interpolation on the CCTV video of FIG. 8.

FIG. 10 is a view illustrating a series of image frames of a compressed video in the present invention.

### DESCRIPTION OF SPECIFIC EMBODIMENTS

Hereinafter, the present invention shall be described in detail as below with referring to the accompanying drawings.

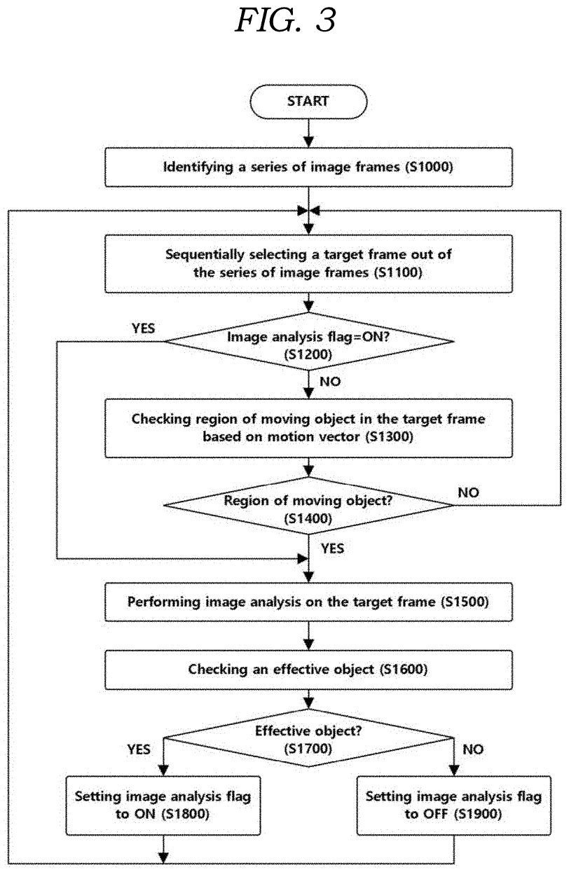

FIG. 3 is a flow chart illustrating an embodiment of the video analysis method according to the present invention. According to the present invention, a video analysis server of a video analysis system may effectively perform video analysis of a compressed video (e.g., H.264 AVC, H.265 HEVC) by use of branching by motion vector.

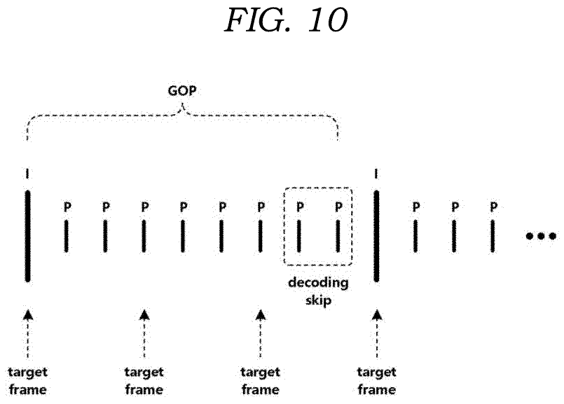

Step (S1000): The video analysis server processes the compressed video so as to identify a series of image frames out of the compressed video. According to the video compression technical standards, a compressed video may comprise a series of image frames as shown in FIG. 10.

Step (S1100): Then, the video analysis server sequentially selects target frames for image analysis out of the series of image frames according to a predetermined selection rule. The series of image frames may be selected one by one for image analysis. Alternatively, image frames may be selected intermittently at around 3-4 frames-per-second for image analysis.

Step (S1200): The video analysis server checks whether an image analysis flag is ON. The image analysis flag shall be set to ON or OFF in (S1800) and (S1900) in this specification. The initial value of the image analysis flag is presumed as OFF for convenience.

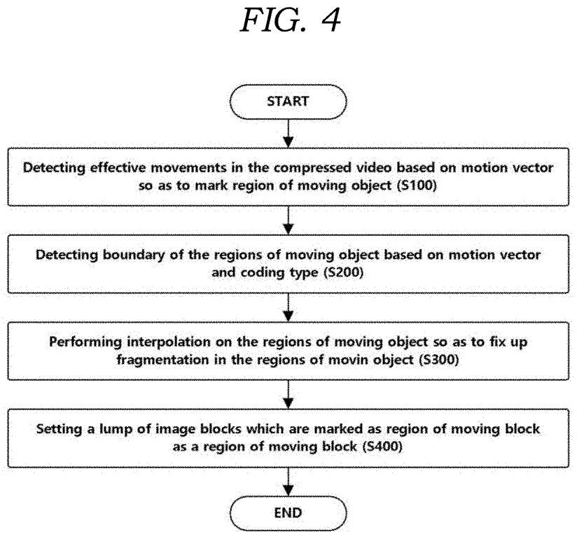

Steps (S1300, S1400): If image analysis flag is OFF, the video analysis server checks whether a region of moving object is detected in the target frame based on a motion vector accumulation for a predetermined time-period which is obtained by bit-stream parsing of the compressed video. The procedure (S1300) of checking whether a region of moving object is detected in the target frame based on a motion vector accumulation shall be described below with referring to FIG. 4.

If a region of moving object fails to be detected in (S1300), the video analysis server skips image analysis for the target frame and proceeds to (S1100) with presuming that the target frame does not include any substantial information. In this case, for that target frame, only bit-stream parsing and some arithmetic operations need to be done without performing complicated processing, e.g., decoding, downscale resizing, differential image obtaining, and playback image analysis. That means that computing resource may be lowered.

Steps (S1500˜S1900) : If image analysis flag is OFF in (S1200), the video analysis server proceeds directly to (S1500) without going through (S1300) and (S1400). Further, if a region of moving object is detected in (S1300), the video analysis server proceeds to (S1500) with considering that the target frame may include substantial information.

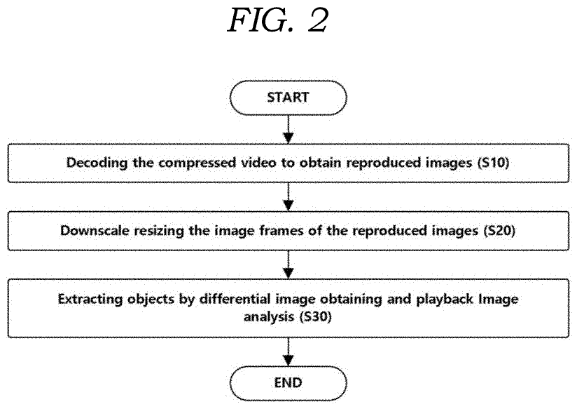

In (S1500), the image analysis is performed on the target frame in order to check an effective object. For example, object can be checked in the target frame by decoding, downscale resizing, differential image obtaining, and playback image analysis, as described in FIG. 2. The object which is detected in (S1500) by the image analysis is referred to as ‘an effective object’ in this specification in order to distinguish it from the region of moving object which is detected in (S1300).

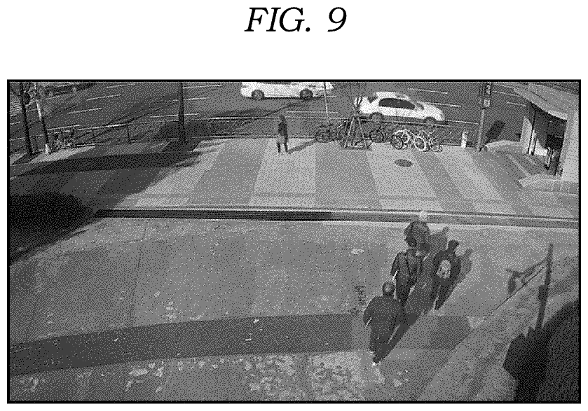

In an embodiment, the image analysis of (S1500) is performed on the entire image frames, not only on the regions of moving object (e.g., blue regions in FIG. 9) detected in (S1300). At this time, the image analysis may be performed on the entire image frames when even a very small region of moving object is found. In another embodiment, the image analysis of (S1500) (i.e., decoding, downscale resizing, differential image obtaining, playback image analysis) is performed only on the regions of moving object detected in (S1300). The image analysis speed is faster in the latter embodiment.

Then, in (S1600), it is checked whether an effective object is detected by the image analysis of (S1500). If an effective object is detected in (S1500), the image analysis flag is set to ON in (S1800), and then the process proceeds to (S1100). That is, when an effective object is detected in (S1500), by setting the image analysis flag to ON, the image analysis of (S1500) shall be performed on a series of target images until the effective object disappears from the playback video. If the effective object disappears from the playback video, the image analysis of (S1500) fails to detect the effective object. In this case, the image analysis flag is set to OFF in (S1900), and then the process proceeds to (S1100).

On the other hand, if the target frame is a P frame which is located within a predetermined number at the rear end of the GOP, the image analysis for the target frame is skipped and the process proceeds to (S1100).

FIG. 10 is a view illustrating a series of image frames of a compressed video in the present invention. In FIG. 10, I (Intra) frame can be decoded by itself, and P (Prediction or Inter) frame may be decoded only after its last I frame as well as the immediately preceding P frame were decoded. GOP (Group of Pictures) is a bundle of one I frame (Key Frame) and P frames, and is the minimum unit for completely decoding a compressed video.

In general, considering computing resource, the video analysis server does not perform image analysis on all of the frames, but only on about 3 or 4 frames-per-second. For example, it is assumed that the compressed video has 30 frames-per-second and the video analysis server performs image analysis once every 10 frames. In a GOP, the video analysis server performs image analysis on the leading I frame, and then performs image analysis on every 10 P frames. Then, in a GOP, there is no need to analyze the P frames which are located within 9 of the rear end of the GOP, i.e., the 21st to 29th P frames. This decoding skipping may let the computing resources lowered. Meanwhile, in some embodiments, the B frame may be mixed with the P frames in FIG. 10.

FIG. 4 is a flow chart illustrating an embodiment of the procedure of extracting regions of moving object in a compressed video by use of motion vectors in the present invention. The procedure of FIG. 4 corresponds to (S1300) of FIG. 3.

In the present invention, the regions which appear to be moving object (i.e., regions of moving object) may be extracted from a compressed video with referring to syntax information. That is, while being unaware of the contents or story of the compressed video, lumps of images which are presumed to include moving object may be extracted with referring to syntax information. For this purpose, without necessity of decoding compressed video, regions of moving object may be extracted quickly by use of the syntax information of each of image blocks which are obtained by bit-stream parsing of the compressed video. The image blocks may be any one or a combination of macro blocks or sub-blocks, etc. The syntax information may be preferably motion vector and coding type. The regions of moving object which are thus obtained may fail to accurately reflect the boundary line of the moving objects. However, the processing speed is fast and the reliability is high, as confirmed in several images attached to this specification.

Step (S100): First, effective movements to which substantial meaning may be given are detected in the compressed video based on motion vector of the compressed video. Then, the image regions in which the effective movements are detected are set as regions of moving object.

For this purpose, motion vector and coding type is parsed for coding units of the compressed video according to video compression technical standard such as H.264 AVC or H.265 HEVC, etc. The size of the coding unit is usually more or less 64×64 pixel 4×4 or 4×4 pixel. However, the size may be flexibly configured. For each of image blocks, motion vectors are accumulated for a predetermined time-period of a plurality of frames (e.g., 500 msec). For example, if the compressed video has 30 frames-per-second, motion vectors are accumulated for each of image blocks for 15 frames (i.e., 500 msec). Then, the motion vector accumulation is checked whether it is higher than a predetermined first threshold (e.g., 20). When an image block is found which has the motion vector accumulation higher than a predetermined first threshold, it is regarded that effective movement is found in the image block, and accordingly the found image block is marked as region of moving object. On the other hand, even if motion vectors are obtained in an image block, if its motion vector accumulation for a specific time-period fails to be higher than the first threshold, it is regarded that corresponding change in video is rather small, and accordingly the image block shall not be marked as region of moving object.

Because the present invention only checks whether regions of moving object are detected in an image frame of a compressed video, (S1300) can be accomplished by only (S100). However, in order to detect regions of moving object more correctly, it is preferable to further perform boundary check (S200) and interpolation (S300), which shall be described below.

Step (S200): Then, for the regions of moving object which have been detected in (S100), the extent of boundary area is detected by use of motion vector and coding type. Through this procedure, by clumping up the regions of moving object which were marked in a fragmented pattern in (S100), a meaningful lump of image blocks shall become formed.

In (S100), by applying a strict criteria, image blocks which surely correspond to moving objects are selected in the compressed video and marked as region of moving object. In (S200), other image blocks shall be examined, which are positioned around the image blocks which were marked as region of moving object in (S100). These are referred to herein as ‘neighbor blocks’ for convenience. These neighboring blocks shall be checked whether they are regions of moving object by looser criteria than in (S100).

In a compressed video, macro blocks and sub-blocks are very small in size. Therefore, if the compressed video is an image of persons, cars or animals, such as a CCTV video, due to its characteristics, it is difficult for a moving object to appear only in one or a few image blocks. Rather, it is expected that the moving object shall appear across several image blocks. That is, it is expected that the probability of including moving objects is higher for image blocks which are positioned around the image blocks which include moving objects than for other image blocks. Reflecting the expectation, in (S200), for the neighboring blocks which are positioned around the regions of moving object, a relatively looser criteria is applied in checking whether the image blocks shall be marked as region of moving object.

In one embodiment, each of the neighboring blocks is examined and is marked as region of moving object when its motion vector is higher than a predetermined second threshold (e.g., 0) or when its coding type is Intra Picture. In other embodiment, each of the neighboring blocks is examined and is marked as region of moving object when the motion vector accumulation of (S100) is higher than a predetermined third threshold (e.g., 5) or when its coding type is Intra Picture. It is logical that the second threshold and the third threshold shall be smaller values than the first threshold.

Conceptually, if a image block having some movement is found in the vicinity of a region of moving object in which substantially effective movements have already been confirmed, it is highly probable that the image block would form a single lump with the region of moving object. That is why the image block is also marked as region of moving object. Further, because the motion vector is unavailable for Intra Picture, it is impractical to examine the neighboring blocks of Intra Picture based on motion vector. In this case, the neighboring blocks of Intra Picture may be marked as region of moving object, so as to let the neighboring blocks of Intra Picture to form a single lump with the adjacent image blocks which have already been marked as region of moving object. The loss when one image block is wrongly marked as region of moving object is small, whereas the loss when the region of moving object is fragmented is big.

Step (S300): The interpolation is performed on the regions of moving object which were detected in (S100) and (S200) so as to fix up fragmentation in the regions of moving object. In the previous procedure, regions of moving object were marked in a unit of an image block. Accordingly, although it is actually a single moving object (e.g., a human, a car), due to some unmarked image blocks which are sparsely mixed between regions of moving object, the single moving object may be fragmented into a plurality of regions of moving object. These unmarked image blocks may let the plurality of regions of moving object be handled as separate moving objects. This fragmentation shall let the detection of moving objects be inaccurate. Therefore, if one or small number of unmarked image blocks are found with being surrounded by a plurality of marked image blocks, they are also marked as region of moving object. In this specification, the procedure is referred to as ‘interpolation’. Further, in this specification, ‘marked image block’ means an image block which has been already marked as region of moving object, and ‘unmarked image block’ means an image blocks which is not marked as region of moving object yet. Through this procedure, a plurality of regions of moving object can be clumped up so as to form a single lump as shown in FIG. 9.

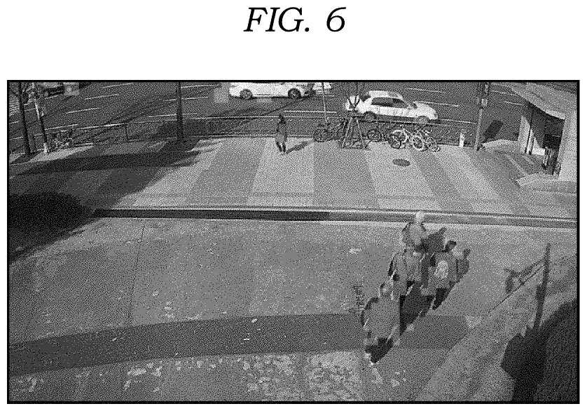

Comparing FIGS. 6, 8 and 9, it may be identified that regions of moving object become to properly reflect the CCTV video through the procedures of the boundary expansion and the interpolation. If moving objects are handled with referring to red lumps in FIG. 6, it will be treated as if a large number of very small objects are moving, which does not correspond to the actual situation in the CCTV video. On the other hand, if moving objects are handled with referring to blue lumps in FIG. 9, it will be treated that several objects with a certain volume are moving, which does similarly reflect the actual situation in the CCTV video.

Step (S400): One or more regions of moving object were obtained from a compressed video through (S100) to (S300). In each of (S100) to (S300), it was checked whether each of image blocks belongs to region of moving object and then marked. However, in the end, the image blocks which were marked as region of moving object shall be clumped each other so as to form a lump of image blocks. The lump of image blocks, each of which was marked as region of moving object, shall be treated as a region of moving object. As shown in FIG. 9, the region of moving object is a lump of a plurality of image blocks. The region of moving object is an area where one or more moving objects are presumed to exist therein based on syntax information (e.g., motion vector).

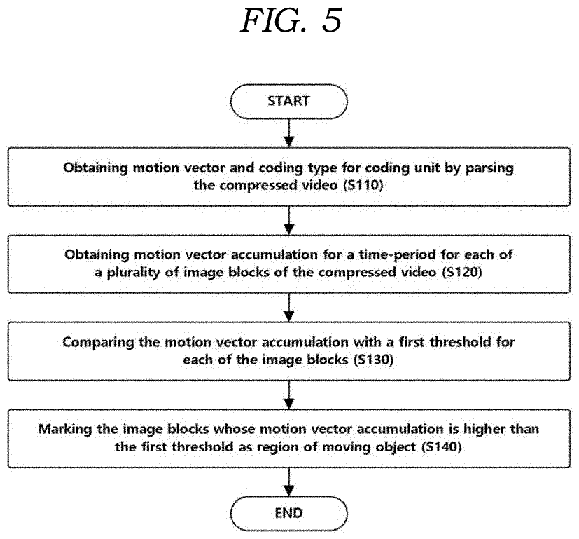

FIG. 5 is a flow chart illustrating an embodiment of the procedure of detecting regions of effective movement in a compressed video in the present invention. FIG. 6 is a view illustrating an example of the result of performing the procedure of detecting regions of effective movement on a CCTV video. The procedure of FIG. 5 corresponds to (S100) of FIG. 4.

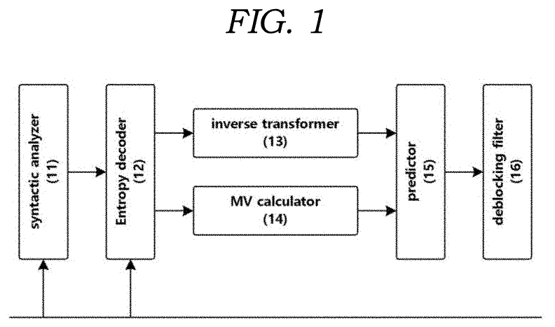

Step (S110): Firstly, the bit-stream of the compressed video is parsed so as to obtain motion vector and coding type for coding unit. Referring to FIG. 1, the syntactic analyzer 11 performs syntactic analysis (header parsing) and motion vector calculation for bit-stream of the compressed video by a video compression technical standard (e.g., H.264 AVC, H.265 HEVC). By this procedure, motion vector and coding type is obtained for coding unit of the compressed video.

Step (S120): The motion vector accumulation for a predetermined time-period (e.g., 500 ms) is obtained for each of a plurality of image blocks which constitutes the compressed video. This step is proposed in order to detect any substantially meaningful movement (i.e., effective movement) in the compressed video, e.g., cars in driving, running peoples, and crowds fighting each other. The objects of substantially meaningless movement may not be detected, e.g., shaking leaves, temporal ghosts, and shadows that change slightly by the reflection of light. For this purpose, motion vectors are accumulated for a predetermined time-period (e.g., 500 msec) for unit of image block. The term of ‘image block’ may include macro blocks and sub-blocks in this specification.

Steps (S130, S140): For the plurality of image blocks, the motion vector accumulation is compared with a predetermined first threshold (e.g., 20). Then, image blocks whose the motion vector accumulation is higher than the first threshold are marked as regions of moving object. That is, when an image block having such a big motion vector accumulation is found, it is presumed that some substantially meaningful movement (i.e., an effective movement) has been found in that image block. For example, any movement to which monitoring agents of video surveillance system worth paying attention, e.g., a person who is running, may be selectively detected. On the other hand, if any motion vector whose accumulation value for a specific time-period fails to be higher than the first threshold shall be ignored in detecting procedure under estimating that the change in video is rather small.

FIG. 6 is a view illustrating an example of the result of performing the procedure of detecting regions of effective movement of FIG. 5 on a CCTV video. In FIG. 6, a plurality of image blocks with the motion vector accumulation higher than the first threshold are marked as region of moving object, and are colored in red on monitor screen. Referring to FIG. 6, sidewalk blocks, roads, and shade parts are not marked as region of moving object, whereas walking peoples or cars in driving are marked as region of moving object.

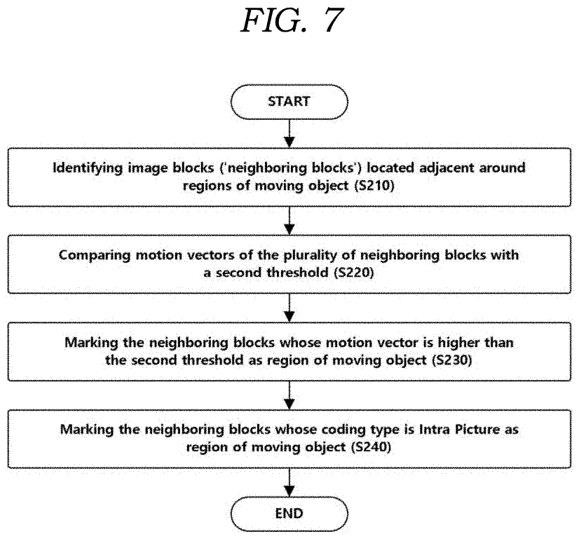

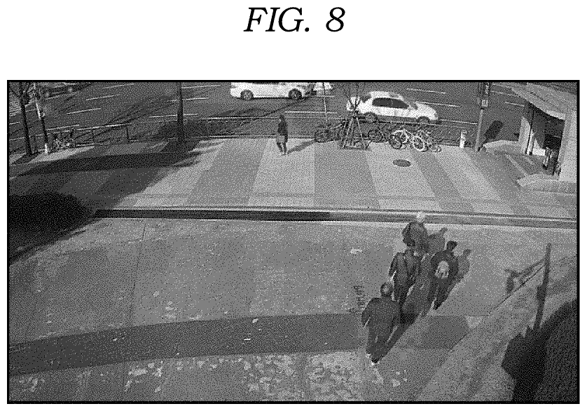

FIG. 7 is a flow chart illustrating an embodiment of the procedure of detecting boundary area of region of moving object in the present invention. FIG. 8 is a view illustrating the result of performing the procedure of detecting boundary area on the CCTV video of FIG. 6. The procedure of FIG. 7 corresponds to (S200) of FIG. 4.

Referring to FIG. 6, it may be found that moving objects have been inappropriately marked, that is, only a part of moving objects are marked. When examining walking peoples or cars in driving in FIG. 6, it is found that only some of image blocks of those objects are marked as region of moving object. Further, it is also found that a plurality of regions of moving object have been marked in one moving object. That means that the criteria in (S100) of marking region of moving object is useful in filtering out normal regions, but is too strict. Therefore, in order to identify regions of moving object more correctly, it is preferable to further investigate the surroundings of regions of moving object which have been marked in (S100). When the image blocks of the surroundings satisfy predetermined criteria, they shall be further marked as region of moving object, so that the boundary of moving objects may be detected.

Step (S210): First, it is identified a plurality of image blocks which are located adjacent around the image blocks which were marked as region of moving object in (S100). For convenience, they are referred to as ‘neighboring blocks’ in this specification. These neighboring blocks were not marked as region of moving object in (S100). In the procedure of FIG. 7, the neighboring blocks are further examined in order to identify some of the neighboring blocks may be further marked as region of moving object.

Steps (S220, S230): The values of motion vectors of the neighboring blocks are compared with a predetermined second threshold (e.g., 0). Then, some of the neighboring blocks whose motion vector is higher than the second threshold shall be marked as region of moving object. It shall be reminded that substantially effective movements have been confirmed in the regions of moving object in (S100). Therefore, if some movement is found in image blocks which are located adjacent around a region of moving object, when considering the characteristics of shooting video (e.g., CCTV video), the image blocks are likely to be a single lump with the adjacent region of moving object. That is why these neighboring blocks are also marked as region of moving object.

In one embodiment, each of the neighboring blocks is examined and is marked as region of moving object when its motion vector is higher than a predetermined second threshold (e.g., 0). In other embodiment, each of the neighboring blocks is examined and is marked as region of moving object when the motion vector accumulation of (S100) is higher than a predetermined third threshold (e.g., 5). It is logical that the second threshold and the third threshold shall be smaller values than the first threshold.

Step (S240): Further, some of the neighboring blocks whose coding type is Intra Picture shall be marked as region of moving object. Because the motion vector is unavailable for Intra Picture, it is impractical to examine the neighboring blocks of Intra Picture based on motion vector as in (S220) and (S230). In this case, it is preferable to let the neighboring blocks of Intra Picture be marked as region of moving object, so as to let the neighboring blocks of Intra Picture to form a single lump with the adjacent image blocks which have already been marked as region of moving object. The loss when one image block is wrongly marked as region of moving object is small, whereas the loss when the region of moving object is fragmented is big.

FIG. 8 is a view illustrating the result of performing the procedure of detecting boundary area on the CCTV video of FIG. 6. In FIG. 8, a number of image blocks which were marked as region of moving object through the above procedure are colored in blue. Referring to FIGS. 6 and 8, the regions of moving object in blue color have been further expanded around the regions of moving object in red color. When comparing with the CCTV video, it may be identified that the regions of moving object in blue color better cover the moving objects in the CCTV video.

The present invention may provide an advantage of lowering the computer resource required for analyzing a compressed video (e.g., CCTV video) by selectively performing image analysis. Especially, the present invention may provide more or less 5 times more channel capacity than conventional video analysis systems because the present invention requires more or less ⅕ less computing resources in analyzing a compressed video.

Meanwhile, the present invention can be implemented in the form of a computer-readable code on a non-transitory computer-readable medium. Various types of storage devices exist as the non-transitory computer-readable medium, such as hard disks, SSDs, CD-ROMs, NAS, magnetic tapes, web disks, and cloud disks. The codes may be distributed, stored, and executed in multiple storage devices which are connected through a network. Further, the present invention may be implemented in the form of a computer program stored in a medium in order to execute a specific procedure by being combined with hardware.

What is claimed is:

1. A video analysis method of a compressed video by use of branching by motion vector, the method comprising:
identifying a series of image frames out of the compressed video;
sequentially selecting a target frame out of the series of image frames according to a predetermined selection rule;
checking an image analysis flag;
if the image analysis flag is OFF, determining detection of a region of moving object in the target frame based on a motion vector accumulation which is obtained by bit-stream parsing of the compressed video;
if the image analysis flag is OFF and a region of moving object fails to be detected in the determining detection of a region of moving object, skipping image analysis for the selected target frame and proceeding to the selecting target frames;
if the image analysis flag is ON or a region of moving object is detected in the determining detection of a region of moving object, determining detection of an effective object in the selected target frame by image analysis on the selected target frame;
if an effective object fails to be detected in the determining detection of an effective object, setting the image analysis flag to OFF and proceeding to the selecting target frames; and
if an effective object is detected in the determining detection of an effective object, setting the image analysis flag to ON and proceeding to the selecting target frames.

2. The video analysis method of claim 1, wherein the method further comprising:
if the selected target frame is a P frame which is located within a predetermined number at the rear end of the GOP, skipping image analysis for the selected target frame and proceeding to the selecting target frames.

3. The video analysis method of claim 2, wherein the determining detection of a region of moving object comprises:
parsing the bit-stream of the compressed video so as to obtain motion vector and coding type for coding unit;
obtaining motion vector accumulation for a predetermined time-period for each of a plurality of image blocks which constituting image frames of the compressed video;
identifying image blocks whose motion vector accumulation are higher than a predetermined first threshold; and
marking the identified image blocks as region of moving object.

4. The video analysis method of claim 3, wherein the determining detection of a region of moving object further comprises:
identifying a plurality of image blocks (hereinafter referred to as ‘neighboring blocks’) around the image blocks which are marked as region of moving object;
marking as region of moving object some of the neighboring blocks whose coding type is Intra Picture;
identifying neighboring blocks whose motion vector are higher than a predetermined second threshold;
further marking the identified neighboring blocks as region of moving object;
performing interpolation on the image frames of the compressed video, by which unmarked image blocks which are surrounded by a plurality of marked image blocks are marked as region of moving object, wherein the marked image blocks are image blocks which are marked as region of moving object, wherein the unmarked image blocks are image blocks which are not marked as region of moving object yet, and wherein the number of unmarked image blocks is less than a predetermined threshold value; and
setting a lump of marked image blocks as a region of moving object, wherein the lump is formed by clumping up the marked image blocks.

5. A non-transitory computer program contained in a non-transitory storage medium comprising program code instructions which execute a video analysis method of a compressed video by a computer hardware device by use of branching by motion vector, the method comprising:
identifying a series of image frames out of the compressed video;
sequentially selecting a target frame out of the series of image frames according to a predetermined selection rule;
checking an image analysis flag;
if the image analysis flag is OFF, determining detection of a region of moving object in the target frame based on a motion vector accumulation which is obtained by bit-stream parsing of the compressed video;
if the image analysis flag is OFF and a region of moving object fails to be detected in the determining detection of a region of moving object, skipping image analysis for the selected target frame and proceeding to the selecting target frames;
if the image analysis flag is ON or a region of moving object is detected in the determining detection of a region of moving object, determining detection of an effective object in the selected target frame by image analysis on the selected target frame;
if an effective object fails to be detected in the determining detection of an effective object, setting the image analysis flag to OFF and proceeding to the selecting target frames; and
if an effective object is detected in the determining detection of an effective object, setting the image analysis flag to ON and proceeding to the selecting target frames.

6. The non-transitory computer program of claim 5, wherein the method further comprising:
if the selected target frame is a P frame which is located within a predetermined number at the rear end of the GOP, skipping image analysis for the selected target frame and proceeding to the selecting target frames.

7. The non-transitory computer program of claim 6, wherein the determining detection of a region of moving object comprises:
parsing the bit-stream of the compressed video so as to obtain motion vector and coding type for coding unit;
obtaining motion vector accumulation for a predetermined time-period for each of a plurality of image blocks which constituting image frames of the compressed video;
identifying image blocks whose motion vector accumulation are higher than a predetermined first threshold; and
marking the identified image blocks as region of moving object.

8. The non-transitory computer program of claim 7, wherein the determining detection of a region of moving object further comprises:
identifying a plurality of image blocks (hereinafter referred to as ‘neighboring blocks’) around the image blocks which are marked as region of moving object;
marking as region of moving object some of the neighboring blocks whose coding type is Intra Picture;
identifying neighboring blocks whose motion vector are higher than a predetermined second threshold;
further marking the identified neighboring blocks as region of moving object;
performing interpolation on the image frames of the compressed video, by which unmarked image blocks which are surrounded by a plurality of marked image blocks are marked as region of moving object, wherein the marked image blocks are image blocks which are marked as region of moving object, wherein the unmarked image blocks are image blocks which are not marked as region of moving object yet, and wherein the number of unmarked image blocks is less than a predetermined threshold value; and
setting a lump of marked image blocks as a region of moving object, wherein the lump is formed by clumping up the marked image blocks.
